(19) United States
(12) Patent Application Publication
(10) Pub. No.: US 2005/0094051 A1
(43) Pub. Date: May 5, 2005

(54) Single piece cover for light guide

(76) Inventors: Ming-Chuan Lin, Taichung (TW); Chin-Liang Chen, Kaohsiung (TW)

Correspondence Address: BIRCH STEWART KOLASCH & BIRCH, PO BOX 747, FALLS CHURCH, VA, 22040-0747, US

(21) Appl. No.: 10/694,885

(22) Filed: Oct. 29, 2003

(51) Int. Cl. G02F 1/1333

(52) U.S. Cl. 349/58

(57) ABSTRACT

An integrated single-piece cover for a light guide is disclosed. The single-piece cover provides first and second spaces to accommodate at least one set of light guides and brightness enhancement films. As the single-piece cover is made from an integrated (one-shaped) process, coming off or separating due to external factors would not happen.

### FIELD OF THE INVENTION

This invention relates to the fixing structure of a light guide. More particularly, the invention is directed to increase the integral strength and crashing resistance ability by fixing several light guides and brightness enhancement films with a single-piece cover.

### BACKGROUND OF THE INVENTION

Multi-faceted color display panels have been popular on the market for the past few years. The backlight source for these multi-faceted color display panels is white LED and several light guides and brightness enhancement films are used to increase luminance. However, the integral structural strength seems insufficient for practical application as a cover along with respective light guide and brightness enhancement film is fixed for each dimension of a display panel. Then, all covers are connected and fastened with a hook or tape. No matter what method is adopted for fixing, two individual covers are forced to be as one. Certain external factors might result in coming off or separation of two covers, which not only increases the defect rate of products, but also wastes the manufacturing cost.

Accordingly, how to design a stationary structure of a light guide that may increase the integral strength efficiently and promote the crashing resistance capability has become one of the major issues concerned.

### SUMMARY OF THE INVENTION

The main purpose of this invention is to improve the aforementioned defects of deficient integral strength and crashing resistance ability by providing a single-piece cover to fix several light guides and brightness enhancement films.

### BRIEF DESCRIPTION OF THE DRAWINGS

FIG. 1 shows a 3-dimensional breakdown illustration of this invention.

FIG. 2 shows another 3-dimensional breakdown illustration of this invention.

FIG. 3 shows a 3-dimensional local assembly diagram of this invention.

### DETAILED DESCRIPTION OF THE REFERRED EMBODIMENT

To facilitate committee members for a better understanding of this invention, a description of the preferred embodiment along with drawings is made in detail as follows:

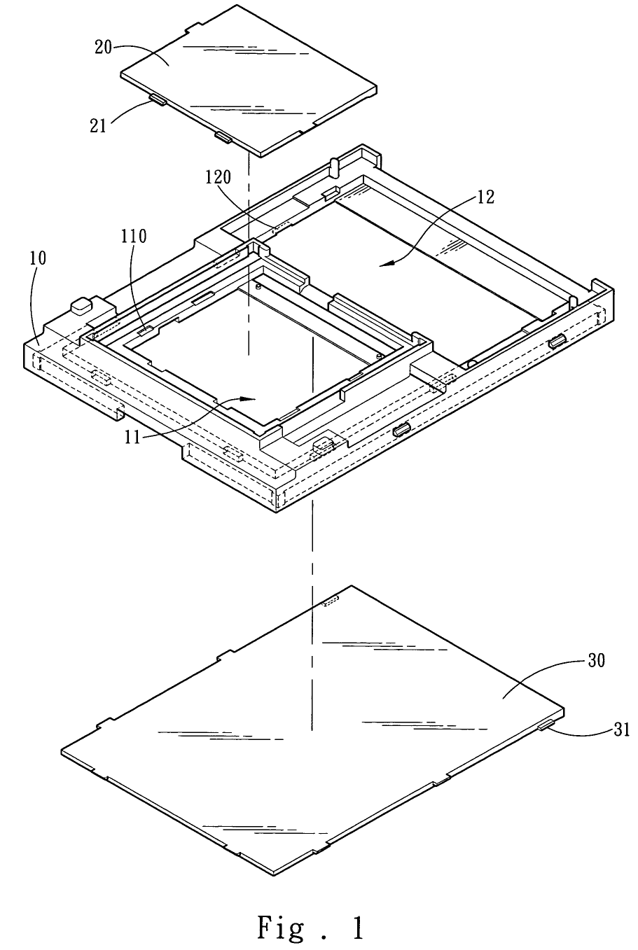

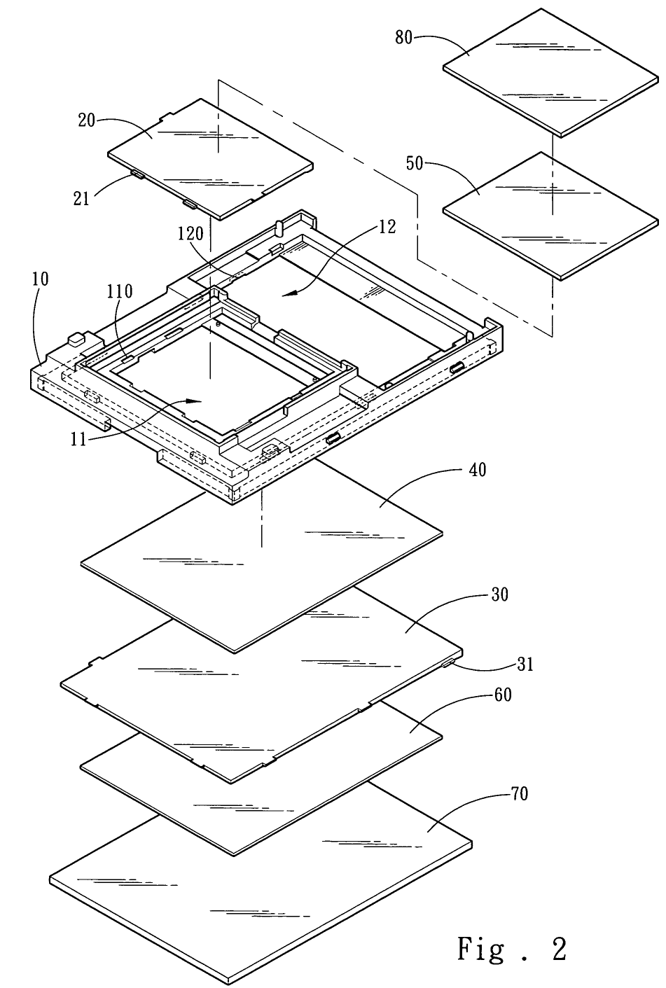

First, refer to FIGS. 1 and 2 for 3-dimensional breakdown illustration of this invention. This invention relating to a single-piece cover for a light guide includes:

A single-piece cover 10 made from an integrated (one-shaped) process providing a first space 11 and a second space 12 with several embedded slots 110 and 120 built in the inner edge;

at least a set of light guides 20 and 30 whose outer edge built with inlays 21 and 31 corresponding to embedded slots 110 and 120;

a polarizer 40 installed between the light guide 20 and the second space 12 of the single-piece cover 10 to project polarized light source;

at least a set of brightness enhancement films 50 and 60 installed on a side of light guides 20 and 30 respectively;

and at least a set of buffers 70 and 80 installed on a side of the brightness enhancement films 50 and 60.

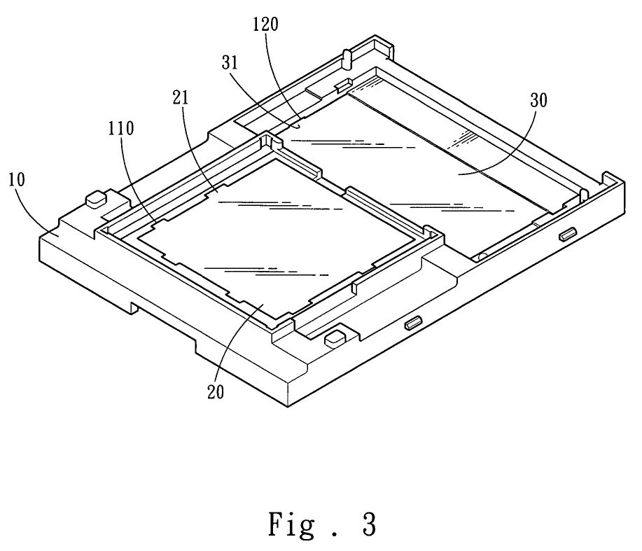

Refer to FIG. 3 of the 3-dimensional local assembly diagram for this invention;

First, place the polarizer 40 unto the second space 12 and then put two light guides 20 and 30 unto the first space 11 and the second space 12 for the inlays 21 and 31 on the outer edge of light guides 20 and 30 to engage with embedded slots 110 and 120 built in the inner edge of the first space 11 and the second space 12 so that two light guides 20 and 30 may be fixed unto the single-piece cover 10.

In addition, place at least the set of brightness enhancement films 50 and 60 on a side of light guides 20 and 30 in order and then put buffers 70 and 80 unto the other side of brightness enhancement films 50 and 60 to prevent the brightness enhancement films 50 and 60 from falling.

The above components form this invention accordingly. The primary feature of this invention puts emphasis on fixing at least the set of light guides 20 and 30 and the brightness enhancement films 50 and 60 by merely an one-shaped single-piece cover 10 instead of using at least two covers to fix respective light guide and brightness enhancement film via hooks or tape used in the typical approach. As a result, the single-piece cover 10 won't come off or separate due to certain external factors, which not only decreases the defect rate of products efficiently, but also reduces unnecessary manufacturing cost.

One thing deserves to be mentioned is that the technology of this invention to be claimed focuses on the increase in integral strength and crashing resistance ability by use of only the single-piece cover 10 formed by two light guides 20 and 30. Therefore, two left-right, up-down or front-rear directed light guides 20 and 30 can be selected in accordance with actual requirements to put the single-piece cover 10 together.

1. A single-piece cover made from an integrated (one-shaped) process for light guides provides first space and second space to accommodate at least one set of light guides and brightness enhancement films; wherein
the single-piece cover is made from an integrated (one-shaped) process leading no coming off or separating due to external factors.

2. The single piece cover for light guide according to claim 1, wherein several embedded slots are built in the inner edge of first and second spaces of the single-piece cover.

3. The single piece cover for light guide according to claim 1, wherein there are inlays on the outer edge of the light guide corresponding to first and second spaces.
